(19) United States
(12) Patent Application Publication
(10) Pub. No.: US 2026/0261583 A1
(43) Pub. Date: Sep. 3, 2026

(54) AUTO DISABLE/RE-ENABLE OF WILDCARD DISCOVERED APPLICATION IN CONNECTOR BASED SOLUTION OF APPLICATION ACCESS IN HIGH SCALE ENVIRONMENT

(71) Applicant: Palo Alto Networks, Inc., Santa Clara, CA (US)

(72) Inventors: Ketan Kulkarni, San Jose, CA (US); Brian Russell Kean, Cincinnati, OH (US); Jayant Jain, Cupertino, CA (US); Mingfei Peng, Pleasanton, CA (US); Uttam Ramesh, Sunnyvale, CA (US)

(21) Appl. No.: 19/068,865

(22) Filed: Mar. 3, 2025

(51) Int. Cl. H04L 9/40; H04L 43/062

(52) U.S. Cl. CPC H04L 63/20; H04L 43/062; H04L 63/101

(57) ABSTRACT

A plurality of applications that have been onboarded are determined. The plurality of applications that are inactive are determined based in part on the telemetry flow records data associated with the plurality of applications. One or more applications of the plurality of applications determined to be inactive are disabled.

### BACKGROUND OF THE INVENTION

A private application deployment environment is a controlled, secure infrastructure where private applications are hosted and managed. These environments are typically used for internal business applications, proprietary software, or services requiring restricted access. An enterprise may deploy thousands (e.g., 80,00-120,000) of applications to the environment. Access to such applications may be provided by a Zero Trust Network Access (ZTNA) connector.

The plurality of applications are onboarded into one or more ZTNA connectors such that users can securely access the applications without being exposed to a broader network. A ZTNA connector is installed and configured within the environment in which an application resides. Resources, such as IP addresses, compute, storage, etc., may be reserved for an application after being onboarded. However, an application may become inactive (e.g., a user has not used the application for a certain period of time). As a result, the resources allocated to the inactive application are underutilized, as they could be reassigned to other applications for use. Given the number of applications deployed in an environment, identifying which are active and which are inactive can be a cumbersome task.

### BRIEF DESCRIPTION OF THE DRAWINGS

Various embodiments of the invention are disclosed in the following detailed description and the accompanying drawings.

FIG. 1 is a block diagram illustrating a system to automatically disable inactive applications in accordance with some embodiments.

FIG. 2 is a flow diagram illustrating a process of disabling an application in accordance with some embodiments.

FIG. 3 is a flow diagram illustrating a process to re-enable a previously disabled application in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods to automatically disable inactive applications and re-enable previously disabled applications are disclosed herein. To onboard and access a large scale of applications, users may use domain name system (DNS) based wildcard application discovery. In this approach, all applications accessed using DNS requests matching a particular wildcard are on-boarded onto a ZTNA connector solution and application access is automatically established. A wildcard DNS query is a type of query where a wildcard character (*) is used in the domain name. This wildcard can match any subdomain. For example, a query like “*.example.com” would return all subdomains of “example.com”, regardless of whether they were specifically set up or not.

These applications can be dynamically created and terminated. Moreover, teams to manage the network access/security are typically different from applications hosting teams and users of the application. For example, an organization's application hosting team may create virtual machine (VM) resources in a datacenter to many groups of employees in the organization. When a particular VM is created, an autogenerated DNS fully qualified domain name (FQDN) is assigned to the VM. Using this FQDN, the particular VM can be accessed. Additionally, this FQDN matches the wildcard configuration on the ZTNA connector configuration and any access to such FQDN will on-board this application on the ZTNA connector. The ZTNA will provide the application access by providing the connectivity and security via a cloud-delivered security platform (e.g., Prisma Access Fabric).

Each created VM appears as a discovered app on the ZTNA connector. However, these VMs and their associated applications are often temporary. After a user is finished with the VM, the application remains unused and untouched. However, the network/security team is not fully aware of application status/usage or its need and it adds up into operational complexity, scale challenges, and fear-to-touch attitude.

The systems and methods disclosed herein manage these applications from a network/security perspective automatically without admin/user intervention in a predictable manner.

For example, a first wildcard application target may be “*.application.local TCP Port 80” and a second wildcard application target may be “*otherapps.local TCP Port 80,443”. 1:n applications may be automatically on-boarded if they have a FQDN that matches the wildcard configuration. For example, applications “one.application.local”, “two.application.local”, . . . , and “n.application.local” as well as “one.otherapps.local”, “two.otherapps.local”, . . . , and “n.otherapps.local” may be on-boarded. In order to provide the access to these applications, a DNS proxy rule is configured which redirects the DNS traffic matching pattern to the ZTNA connector for resolution and discovery of the application for the very first time. For example, a first DNS proxy rule may be “*application.local->100.64.1.1” and a second DNS proxy rule may be “*.otherapps.local->100.64.1.2”.

When applications are discovered by the ZTNA connector, they are onboarded and their corresponding DNS Type A record rules are configured. For example, “one.application.local->100.64.32.1”, “two.application.local->100.64.32.2”, “three.application.local->100.64.32.3” and “four.application.local->100.64.32.4”. There may be many more entries, one entry for each FQDN. Having thousands of applications adds strain on the system to monitor the apps, maintain the routing consistency, and availability of the application across the cloud-delivered security platform.

The systems and methods disclosed herein determine which of the applications are no longer needed. An application may be no longer needed in a plurality of different scenarios. In a first scenario, there is no network traffic associated with the application for prolonged periods of time. An application may be up and running and the FQDN is resolvable, but the application may not be accessed by a user for long periods of time. In a second scenario, the application has been deleted, but the configuration associated with the deleted app still exists in the ZTNA connector (the team deleting the application does not have access to the ZTNA configuration object). Application probes configured on the ZTNA connector will detect these applications are down.

The systems and methods disclosed herein may detect the first scenario using telemetry data to detect an idle application. The telemetry flow records data is exported from a ZTNA connector into a data analytics analyzer. Whenever an application is accessed through a ZTNA connector, the ZTNA connector will generate a flow record and store the application ID as part of the flow records. This flow record is exported to the data analytics analyzer and stored in a time series database.

A query is performed on the time series database. In some embodiments, the query is performed periodically. In some embodiments, the query is performed in response to a command. In some embodiments, the query is for a list of applications that have a flow record in the time series database for a particular period of time (e.g., last 36 hours). The list of applications may be compared to a list of known applications to determine which applications have not been accessed during the particular period of time. In some embodiments, the query is for a list of applications from a plurality of applications that do not have a flow record in the time series database for a particular period of time. In some embodiments, the particular period of time is specified in the query. In some embodiments, the particular period of time is configurable.

The systems and methods disclosed herein may detect the second scenario using one or more application probes. A ZTNA control plane sends a request to a ZTNA connector to report the one or more application probes happening on the ZTNA connector. A probe report includes at least a state of the DNS resolution of the application and/or a health of the application obtained using TCP/ICMP probes (httping/icmp ping). An application is determined to be an inactive application when all of the connectors report the application is unhealthy or down for a prolonged period of time (e.g., 36 hours). The prolonged period of time may be configurable. The ZTNA control plane may determine one or more inactive applications to form a second list of inactive applications.

The ZTNA control plane combines the first list and the second list into a single list and deduplicates applications that appear on both lists. The ZTNA connector utilizes the single list to determine the inactive applications, separately mark each of the determined applications as “unused,” and disable the determined applications. By doing so, all the configuration aspects of these inactive applications are removed from the datapath, the IP addresses associated with these inactive applications are released, and the datapath is no longer aware of these inactive applications. The corresponding DNS rule entry for each of the applications is removed from the DNS proxy configuration. However, the DNS proxy rule of the wildcard application is not removed. That DNS proxy rule remains in the configuration so long as the wildcard application is configured. The systems and methods disclosed herein make the datapath less loaded with configuration that was never needed. This helps the datapath to keep resources for applications that are actually in use, making it more efficient.

Additional visibility is provided to the administrator for the reason for auto-disable of the applications. This reflects the right state of the applications. The admin will know exactly how many applications were auto-disabled, when, and why. Admin can take further action if needed to delete those applications or modify any configuration if needed based on that.

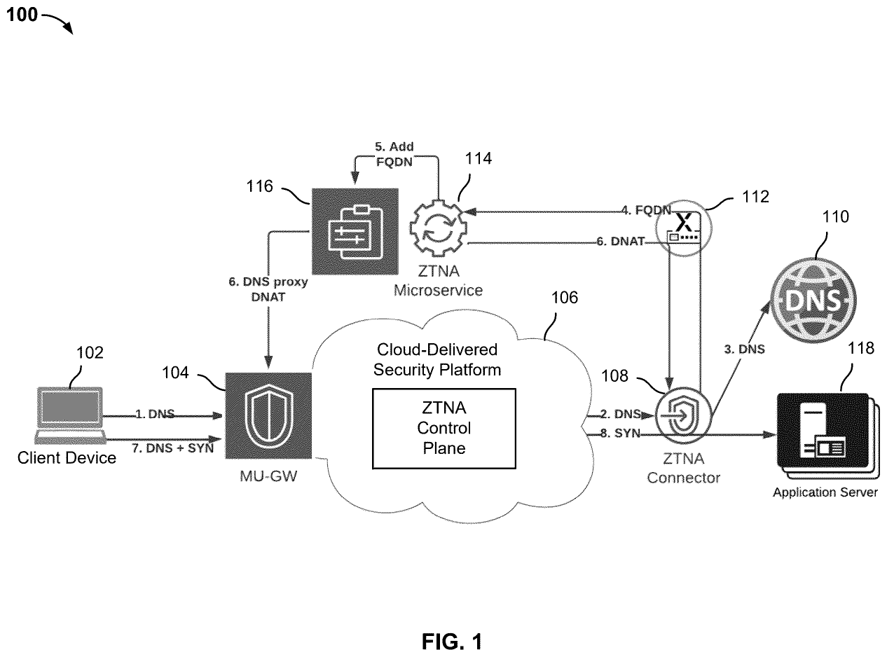

FIG. 1 is a block diagram illustrating a system to automatically disable inactive applications in accordance with some embodiments. In the example shown, system 100 includes a client device 102. Client device 102 may be a computer, a laptop, a desktop, a server, a smartphone, a tablet, or any other network enabled communication device. Client device 102 is configured to provide to mobile user (MU) gateway (GW) 104 a DNS request to a specific FQDN. In response MU-GW 104 executes a DNS resolver to determine what wildcard rule (if any) matches the DNS request.

MU-GW is configured to send the DNS request via a cloud-delivered security platform 106 (e.g., Prisma Access Fabric) to ZTNA connector 108 (e.g., an instance in the connector group for the Prisma Access/SASE (Secure Access Secure Edge) solution, which can be implemented as a container of such connectors executing in a cloud computing environment, such as Google Cloud Platform (GCP). In the example shown, ZTNA connector 108 is in secure communication (e.g., via an IPSEC tunnel) with cloud-delivered security platform 106.

ZTNA connector 108 is configured to forward the DNS request to a data center DNS server 110. In the example shown, DNS server 110 can be configured via Dynamic Host Configuration Protocol (DHCP) on a data center interface. DNS server 110 is configured to resolve the specific FQDN and then send a DNS reply back to ZTNA connector 108 (e.g., as such, the ZTNA connectors can execute a data path element service for this example implementation of SASE solution that facilitates wildcard based private application access).

ZTNA connector 108 is configured to automatically notify cloud controller 112 (e.g., implemented in this example using a commercially available cloud-based controller for controlling ZTNA connector(s) as well as SD-WANs, etc., such as using the commercially available CloudGenix (CGNX) controller or another commercially available cloud controller can be similarly used) that a DNS request initiated by an end user has been resolved. As also shown, cloud controller 112 then forwards this notification to ZTNA microservice 114 (e.g., the ZTNA microservice can be execute in the cloud, such as using GCP or another commercially available cloud computing service can similarly be used for implementing the disclosed cloud-based SASE solution).

ZTNA microservice 114 automatically identifies the most specific wildcard FQDN match and then automatically adds the specific FQDN application with the same matching protocol and port specification to a specific FQDN table 116. As such, this application add is the functional equivalent of an administrator adding the specific FQDN application with the wildcard FQDN application protocol (e.g., example application protocols can include TCP, UDP, etc.) and port specification along with health monitoring.

The DNX proxy DNAT is provided from specific FQDN table 116 to MU-GW 104. In this example implementation, the ZTNA microservice addition of a specific application can be implemented using the following example standard procedure. First, add a virtual IP address (VIP) for application server 118 (e.g., Prisma Access IP address for accessing the application server) to MU-GW along with a DNAT rule (e.g., for translation of the VIP to the private/local IP address associated with application server 118 in the data center for the enterprise, and ZTNA connector 108 periodically updates its mapping, such as if the local IP address server changes or if load balancing for multiple local IP addresses associated with the application server, which can be provided on a session-based load balancing allocation. Second, add the application via an application programming interface (API) (e.g., using a cloud controller/CloudGenix (CGNX) composite API). In this example implementation, one Prisma Access fabric IP address is allocated that is the application VIP to get the data to go to the MU. Another PA Fabric IP address is used for routing the data to the connector. As such, the MU DNAT rule statically DNATs the destination IP from the VIP address to the connector IP for that specific application. The DNAT rule match action is to then DNAT from the Prisma Access fabric IP for that application to the local data center IP address(es). The data center IP routing and the Prisma Access IP routing are kept separated to ease the network design for the deployment. If the same FQDN has multiple individual ports, such as for SSH/HTTP/HTTPS, then each individual application can have its own individual connector IP with individual DNAT rules at the MU and the connector. In some deployments, a given enterprise admin may not desire to separate them and then can just have an aggregate application for TCP or UDP to the FQDN with ports wide open to include all ports.

Client device 102 resends the DNS request (e.g., DNS and SYN packets) for the same specific FQDN, and MU-GW 104 responds with the application VIP. The client device then sends the first application packet, and MU-GW 104 selects a ZTNA connector in the group.

ZTNA connector 108 receives the first packet and automatically performs a network address translation (NAT) of the packet to application server 118 to initiate the connection between client device 102 and application server 118.

In this example implementation, different DNS servers can be specified for different wildcards or types of wildcards. If there is no wildcard match, then a default DNS resolver protocol can be performed. As such, there is a hierarchy of DNS server matches (e.g., to cloud and/or data center located DNS servers).

In this example implementation, the learned FQDNs can be replicated across all MU-GWs for the enterprise, and similarly, for remote node (RN) gateways for the enterprise (e.g., for providing access to remote networks, such as for branch offices, for the enterprise).

As such, the above-described example implementation provides an automated solution that is equivalent to an admin having to manually configure the FQDN when adding a supported application for the enterprise.

As another example, the wildcards can be available across multiple data centers, and the configuration can be automatically determined to match the appropriate application in the desired data center (e.g., regionally route a remote user to the nearest data center with the application, such as users in the US are mapped to the matching application for the wildcard in the US data center, whereas users in Asia are mapped to the matching application for the wildcard in the Asia data center, etc., and/or for load balancing, select data center options based on load balancing, etc.).

After the above procedure has been completed for a particular FQDN application, the admin(s) for the enterprise can view the learned application in, for example, a management console user interface (UI). In this example implementation, the admin(s) can view learned application attributes, such as the following: (1) matching wildcard application indicating his application was learned via DNS wildcard; (2) onboarding time by viewing a wildcard apps onboarding log; and (3) various other application attributes, such as Cortex Data Lake (CDL) (e.g., CDL flow records that include individual session source and destination IP addresses, protocol, and source and destination ports; the flow records can include both pre-NAT, such as for the Prisma Access routing domain, and post-NAT, such as for the data center routing domain, for addresses and ports; as such, it is from here that the specific protocol and port(s) can be derived) and various application statistics.

In some cases, the learned applications may be an application (app) that the admin(s) for the enterprise does not want to allow the end user to access. In this scenario, the admin(s) can add the FQDN to security policies enforced by MU-GW 104 and then delete the learned app. If the same FQDN is resolved, the app will be relearned by the above-described wildcard based private application access solution.

After all the specific FQDNs have been learned over a period of weeks or months, the admin(s) can delete the wildcard application. In this example implementation, the applications learned from the wildcard will remain unless individually deleted.

However, an enterprise may deploy thousands (e.g., 80,00-120,000) of applications to the environment. An application may become inactive (e.g., a user has not used the application for a certain period of time). As a result, the resources allocated to the inactive application are underutilized, as they could be reassigned to other applications for use. Given the number of applications deployed in an environment, identifying which are active and which are inactive can be a cumbersome task.

System 100 may determine which of the applications are no longer needed. An application may be no longer needed in a plurality of different scenarios. In a first scenario, there is no network traffic associated with the application for prolonged periods of time. An application may be up and running and the FQDN is resolvable, but the application may not be accessed by a user for long periods of time. In a second scenario, the application has been deleted, but the configuration associated with the deleted app still exists in the ZTNA connector (the team deleting the application does not have access to the ZTNA configuration file). Application probes configured on the ZTNA connector will detect these applications are down.

ZTNA connector 108 is configured to generate a flow record and store the application ID as part of the flow records whenever an application is access through ZTNA connector 108. Although FIG. 1 depicts one ZTNA connector 108, an enterprise may include 1:n ZTNA connectors associated with 1:n respective application servers. The telemetry flow records data is exported from ZTNA connector 108 (one or more ZTNA connectors) into a data analytics analyzer associated with cloud-delivered security platform 106 and stored in a time series database. A query is performed on the time series database. In some embodiments, the query is performed periodically. In some embodiments, the query is performed in response to a command. In some embodiments, the query is for a list of applications that have a flow record in the time series database for a particular period of time (e.g., last 36 hours). The list of applications may be compared to a list of known applications to determine which applications have not been accessed during the particular period of time. In some embodiments, the query is for a list of applications from a plurality of applications that do not have a flow record in the time series database during a particular period of time. In some embodiments, the particular period of time is specified in the query. In some embodiments, the particular period of time is configurable. A first list of inactive applications is generated based on which applications have not been accessed more than the particular period of time.

A ZTNA control plane associated with cloud-delivered security platform 106 is configured to send a request to ZTNA connector 108 to report the one or more application probes happening on ZTNA connector 108. A probe report includes at least a state of the DNS resolution of the application and/or a health of the application obtained using TCP/ICMP probes (httping/icmp ping). An application is determined to be an inactive application when all of the connectors report the application is unhealthy or down for a prolonged period of time (e.g., 36 hours). The prolonged period of time may be configurable. The ZTNA control plane may determine one or more inactive applications based on the probe reports to form a second list of inactive applications.

The ZTNA control plane combines the first list and the second list into a single list and deduplicates applications that appear on both lists. ZTNA connector 108 utilizes the single list to determine the inactive applications, send a command to ZTNA microservice 114 to separately mark in FQDN table 116 each of the determined applications as “unused,” and disable the determined applications. By doing so, all the configuration aspects of these inactive applications are removed from the datapath, the IP addresses associated with these inactive applications are released, and the datapath is no longer aware of these inactive applications. The corresponding DNS rule entry for each of the applications is removed from the DNS proxy configuration. However, the DNS proxy rule of the wildcard application is not removed. That DNS proxy rule remains in the configuration so long as the wildcard application is configured.

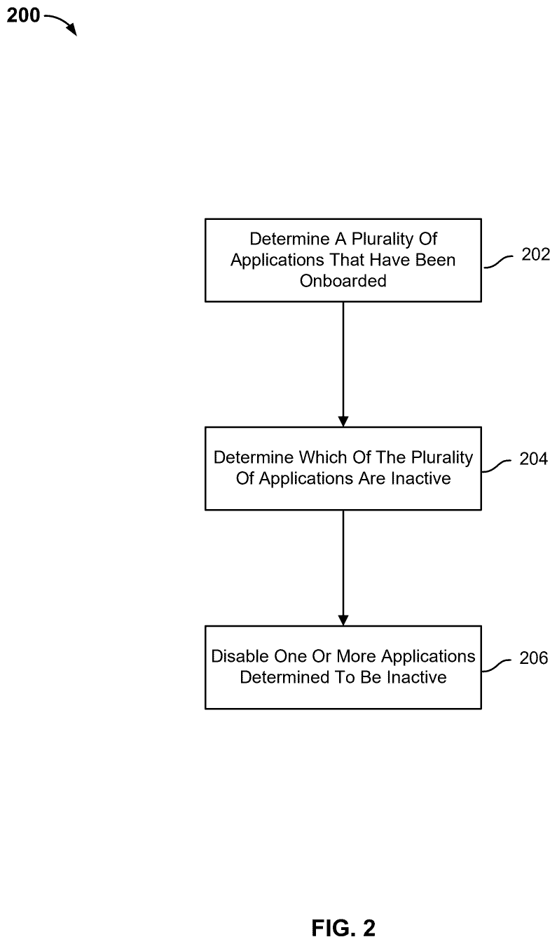

FIG. 2 is a flow diagram illustrating a process of disabling an application in accordance with some embodiments.

At 202, a plurality of applications have been onboarded are determined. One or more ZTNA connectors provide corresponding telemetry flow records data to a data analytics analyzer associated with a cloud-delivered security platform (e.g., Prisma Access). The telemetry flow records data is stored in a time-series database.

At 204, it is determined which of the plurality of applications are inactive.

A query is performed on the time series database. In some embodiments, the query is performed periodically (e.g., daily, weekly, monthly, etc.). In some embodiments, the query is performed in response to a command (e.g., an administrator provides a command to the cloud-delivered security platform). In some embodiments, the query is for a list of applications that have a flow record in the time series database during a particular period of time (e.g., last 36 hours). The list of applications may be compared to a list of known applications to determine which applications have not been accessed during the particular period of time. In some embodiments, the query is for a list of applications from a plurality of applications that do not have a flow record in the time series database for a particular period of time. In some embodiments, the particular period of time is specified in the query. In some embodiments, the particular period of time is configurable. A first list of inactive applications is generated based on which applications have not been accessed more than the particular period of time.

A ZTNA control plane associated with the cloud-delivered security platform to sends a request to one or more ZTNA connectors to report the one or more application probes happening on the one or more ZTNA connectors. A probe report includes at least a state of the DNS resolution of the application and/or a health of the application obtained using TCP/ICMP probes (httping/icmp ping). An application is determined to be an inactive application when all of the connectors report the application is unhealthy (e.g., its DNS resolution is successful but the application is not responding to TCP/ICMP probes.) or down/unreachable/unavailable for a prolonged period of time (e.g., 36 hours). The prolonged period of time may be configurable. The ZTNA control plane may determine one or more inactive applications based on the probe reports to form a second list of inactive applications.

At 206, the one or more applications determined to be inactive are disabled. The cloud-delivered security platform provides to ZTNA connectors associated with the inactive applications a command to disable the inactive applications. In response to receiving the command, a ZTNA connector sends a command to a ZTNA microservice to separately mark in a FQDN table each of the determined applications as “unused,” and disable the determined applications.

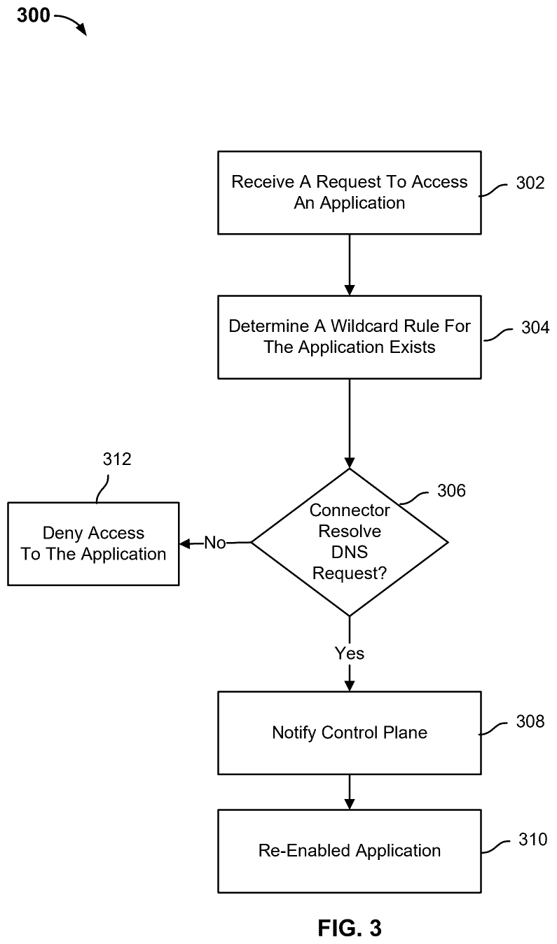

FIG. 3 is a flow diagram illustrating a process to re-enable a previously disabled application in accordance with some embodiments. In some embodiments, an application that was previously auto-disabled may be re-enabled because a user may need the application.

At 302, a request to access an application is received. For example, an app with a FQDN of “one.wildcard.local” may have been disabled. The request may be a DNS query sent for “one. wildcard. local”.

At 304, it is determined that a wildcard rule for the application exists. A MU-GW executes a DNS resolver to determine what wildcard rule (if any) matches a DNS request associated with the application access request. For example, a wildcard rule for “*.wildcard.local” (the original method of discovering the DNS application) may exist. A DNS request for the application is sent to the ZTNA application for resolution.

The MU-GW determines that a wildcard rule for the application in response to the DNS resolver determining that a wildcard rule exists for the application.

At 306, it is determined whether the connector is able to resolve the DNS request. If the ZTNA connector resolves “one.wildcard.local”, “one.wildcard.local” app is discovered from a datapath perspective. The MU-GW notifies a ZTNA control plane.

In response to a determination that the connector is able to resolve the DNS request, process 300 proceeds to 308. In response to a determination that the connector is not able to resolve the DNS request, process 300 proceeds to 312.

At 308, the control plane is notified.

At 310, the application is re-enabled. The ZTNA control plane detects that the app was previously disabled and is now re-discovered by the ZTNA connector. The ZTNA control plan re-enables the application and configures the datapath associated with the application. The ZTNA control plane makes the application as enabled to enable visibility to administrators.

The configuration takes a few seconds and after that the application is accessible to the user again. Thereby providing the ability to auto re-enable the application again. The approach is completely autonomous and no manual intervention is needed. The detection of idle/unused apps happens automatically and so does marking and re-enabling them. This helps manage a high scale environment of application access very easily. No admin/human effort is needed. The operational complexity of such a system reduces a lot thereby saving cost and human efforts. It improves the scale of datapath and control plane by removing unnecessary applications runtime. Thereby saving resources from compute and operational cost perspective.

At 312, access to the application is denied.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining a plurality of applications that have been onboarded;
determining which of the plurality of applications are inactive based in part on telemetry flow records data associated with the plurality of applications; and
disabling one or more applications of the plurality of applications determined to be inactive.

2. The method of claim 1, further comprising obtaining the telemetry flow records data associated with the plurality of applications from one or more zero trust network access (ZTNA) connectors.

3. The method of claim 2, further comprising storing the telemetry flow records data associated with the plurality of applications in a time-series database.

4. The method of claim 1, wherein determining which of the plurality of applications are inactive includes performing a query on a time-series database storing the telemetry flow records data associated with the plurality of applications.

5. The method of claim 4, wherein the query is performed periodically.

6. The method of claim 4, wherein the query is performed in response to a command.

7. The method of claim 4, wherein the query is for a list of applications that have a flow record in the time-series database within a particular period of time.

8. The method of claim 7, wherein the list of applications that have a flow record in the time-series database is compared to a list of known applications to determine which of the plurality of applications are inactive.

9. The method of claim 4, wherein the query is for a list of applications that do not have a flow record in the time-series database within a particular period of time to determine which of the plurality of applications are inactive.

10. The method of claim 1, wherein determining which of the plurality of applications are inactive includes providing to one or more ZTNA connectors a request to report one or more application probes occurring on the one or more ZTNA connectors.

11. The method of claim 10, wherein a probe report received from the one or more application probes includes at least a state of a domain name system (DNS) resolution of an application and/or a health of the application obtained using transmission control protocol (TCP) probes or internet control message protocol (ICMP) probes.

12. The method of claim 10, wherein the one or more applications are determined to be inactive based on probe reports associated with the one or more applications indicating the one or more applications to be unhealthy.

13. The method of claim 10, wherein the one or more applications are determined to be inactive based on probe reports associated with the one or more applications indicating the one or more applications are down for a prolonged period of time.

14. The method of claim 10, wherein determining which of the plurality of applications are inactive includes generating a list of applications based on the one or more probe reports received from the one or more ZTNA connectors.

15. The method of claim 1, wherein determining which of the plurality of applications are inactive includes:
generating a first list of applications based on a query of the telemetry flow records data and a second list of applications based on one or more probe reports received from the one or more ZTNA connectors; and
combining the first list of applications and the second list of applications into a combined list of applications.

16. The method of claim 15, wherein one or more duplicate applications appearing in the combined list of applications are deduplicated.

17. The method of claim 15, wherein the one or more applications included in the combined list of applications are disabled.

18. The method of claim 1, further comprising:
receiving a request to access an application;
determining that a wildcard rule for the application exists;
determining that a ZTNA connector is able to resolve a DNS request associated with the request; and
re-enabling one of the one or more disabled applications.

19. A system, comprising:
a processor configured to:
determine a plurality of applications that have been onboarded;
determining which of the plurality of applications are inactive based in part on the telemetry flow records data associated with the plurality of applications; and
disabling one or more applications of the plurality of applications determined to be inactive; and
a memory coupled to the processor and configured to provide the processor with instructions.

20. A computer program product embodied in a non-transitory computer readable medium and comprising computer instructions for:
determining a plurality of applications that have been onboarded;
determining which of the plurality of applications are inactive based in part on the telemetry flow records data associated with the plurality of applications; and
disabling one or more applications of the plurality of applications determined to be inactive.
